(19) United States
(12) Patent Application Publication
(10) Pub. No.: US 2007/0079354 A1
(43) Pub. Date: Apr. 5, 2007

(54) Tuner having attenuation function and control method for the same

(76) Inventor: Jong-Bae Lee, Suwon-si (KR)

Correspondence Address: Robert E. Bushnell, Suite 300, 1522 K Street, N.W., Washington, DC, 20005, US

(21) Appl. No.: 11/475,204

(22) Filed: Jun. 27, 2006

(30) Foreign Application Priority Data
Oct. 5, 2005 (KR) 10-2005-0093606

(51) Int. Cl. H04N 7/16

(52) U.S. Cl. 725/149

(57) ABSTRACT

Provided is a tuner having an attenuation function and a control method for the same. The tuner includes an attenuation unit that, when the power of the broadcast signal exceeds a strong-electric-field critical value, attenuates the broadcast signal and outputs the attenuated broadcast signal. Therefore, even when a received broadcast signal is more powerful than a strong-electric-field critical value, the power of the broadcast signal can be lowered to prevent interference between channels, thereby providing stable broadcast reception.

### CLAIM OF PRIORITY

This application makes reference to, incorporates the same herein, and claims all benefits accruing under 35 U.S.C. §119 from an application for TUNER AND CONTROL METHOD FOR HAVING ATTENUATOR FUNCTION filed in the Korean Intellectual Property Office on 5 Oct. 2005 and there duly assigned Serial No. 10-2005-0093606.

### BACKGROUND OF THE INVENTION

1. Field of the Invention

The present invention relates to a tuner having an attenuation function.

2. Related Art

A general cable broadcasting system comprises a broadcasting station that broadcasts a signal, and a plurality of subscribers connected to the broadcasting station via a medium.

Here, the subscribers have receiving devices for receiving the signal broadcast from the broadcasting station, and the receiving devices include tuners for controlling a gain of the broadcast signal.

Therefore, the broadcast signal is sent from the broadcasting station to the subscribers via the medium and received by the subscribers through the receiving devices.

For a broadcast signal input to the receiving devices in this way, a gain is automatically controlled by the tuner. Simultaneously, in the tuner, the broadcast signal is converted into an intermediate frequency (IF) signal and input to a demodulator. Here, the gain of the broadcast signal is controlled because the demodulator requires a uniform level signal.

The signal input to the demodulator is demodulated into a moving picture experts group (MPEG) signal and input again to an MPEG decoder.

The MPEG decoder decodes the input MPEG signal into a video signal and a voice signal and outputs the signals.

In the tuner of the receiving devices, a gain controller for the broadcast signal is divided into a radio frequency (RF) automatic gain control (AGC) unit that automatically controls the gain of a broadcast signal having a strong electric field, and an intermediate frequency (IF) AGC unit that automatically controls the gain of a broadcast signal having a weak electric field. The gain controller having such a structure uniformly maintains the power of the input broadcast signal. In other words, a boundary between the RF AGC unit and the IF AGC unit is called a TOP portion, the IF AGC amplification unit controls a broadcast signal having a weak electric field, and the RF AGC amplification unit controls a broadcast signal having a strong electric field.

However, as a cable serving as a transmission medium between a cable broadcasting station and subscribers gets old and worn, the cable broadcasting station amplifies an output power of a broadcast signal and broadcasts the amplified signal.

When the cable broadcasting station amplifies the output power of the broadcast signal beyond a critical value of a strong electric field and sends out the amplified broadcast signal, a subscriber near the cable broadcasting station receives the broadcast signal amplified beyond the critical value as is, without attenuation due to the line. Therefore, the RF AGC amplification unit and IF AGC amplification unit do not control the gain, and harmonic components of each channel interfere with other channels, so that the subscriber cannot view desired broadcasting

### SUMMARY OF THE INVENTION

It is an object of the present invention to provide a tuner having an attenuation function for improving multi channel characteristics in response to receipt of a broadcast signal having a strong electric field from a cable broadcasting station.

According to an aspect of the present invention, there is provided a tuner having an attenuation function and comprising an attenuation unit that, when the power of a broadcast signal received from a broadcasting station exceeds a strong-electric-field critical value, attenuates the broadcast signal and outputs the attenuated broadcast signal.

The attenuation unit may include an attenuator that attenuates the received broadcast signal; a controller that measures the power of the broadcast signal received from a broadcasting station and sends a switching control signal when the power exceeds the strong-electric-field critical value; and a switch that switches the broadcast signal to the attenuator when the switching control signal is received from the controller. Here, the attenuator may be one of a T-shaped attenuator, a Π-shaped attenuator, and a bridge-shaped attenuator.

According to another aspect of the present invention, there is provided a control method for a tuner having an attenuation function, the control method comprising the step of, when the power of a broadcast signal received from a broadcasting station exceeds a strong-electric-field critical value, attenuating the broadcast signal and outputting the attenuated broadcast signal.

The control method may include the steps of judging whether the power of the broadcast signal received from a broadcasting station exceeds a strong-electric-field critical value; when the power of the received broadcast signal exceeds the strong-electric-field critical value in the step of judging, sending a control signal and switching the broadcast signal received from the broadcasting station to thereafter be attenuated; and attenuating the received broadcast signal and outputting the attenuated broadcast signal.

When the power of the received broadcast signal does not exceed the strong-electric-field critical value in the step of judging, the control method may further include the steps of sending another control signal to perform switching such that the received broadcast signal is thereafter not attenuated; and outputting the received broadcast signal without attenuation.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a functional block diagram of a broadcasting system including a tuner having an attenuation function according to an exemplary embodiment of the present invention;

FIGS. 2a, 2b, and 2c are circuit diagrams of an attenuator included in the tuner having an attenuation function according to FIG. 1; and

FIG. 3 is a flowchart showing a process of controlling a tuner having an attenuation function according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. Like elements are denoted by like reference numerals throughout the drawings. Matters related to the present invention and well-known in the art will not be described in detail when deemed that such description would detract from the clarity and concision of the disclosure.

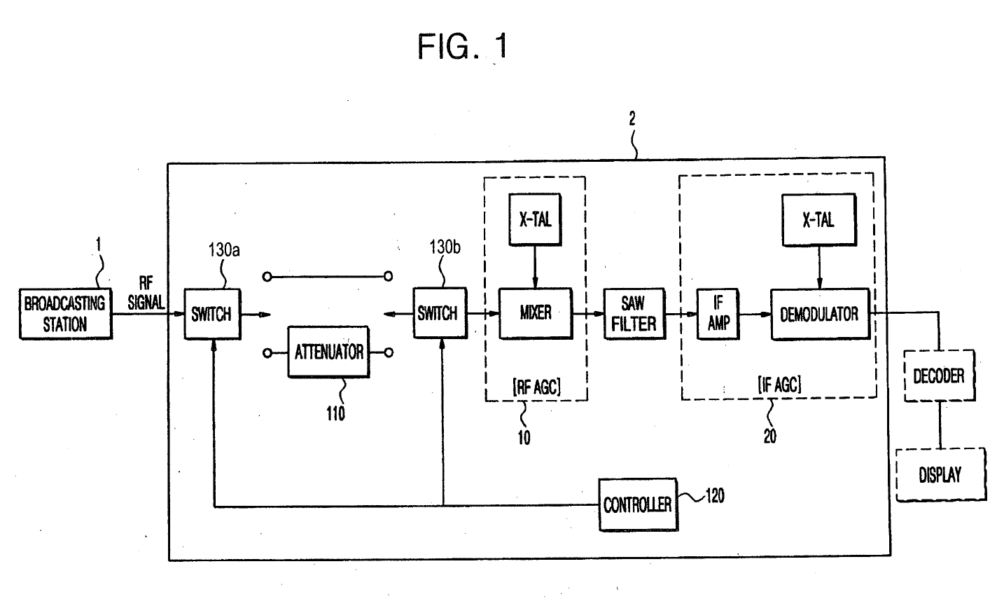

FIG. 1 is a functional block diagram of a broadcasting system including a tuner having an attenuation function according to an exemplary embodiment of the present invention. The broadcasting system according to an exemplary embodiment of the present invention comprises a cable broadcasting station 1 and at least one receiving device (hereinafter called a set-top box) including a tuner 2.

Here, when a power of a broadcast signal received from the cable broadcasting station 1 exceeds a strong-electric-field critical value, the tuner 2 attenuates the broadcast signal and outputs the attenuated broadcast signal. The tuner 2 includes an attenuator 110, a controller 120, and switches 130a and 130b, and further includes a radio frequency (RF) auto gain controller (AGC) 10 and an intermediate frequency (IF) AGC 20.

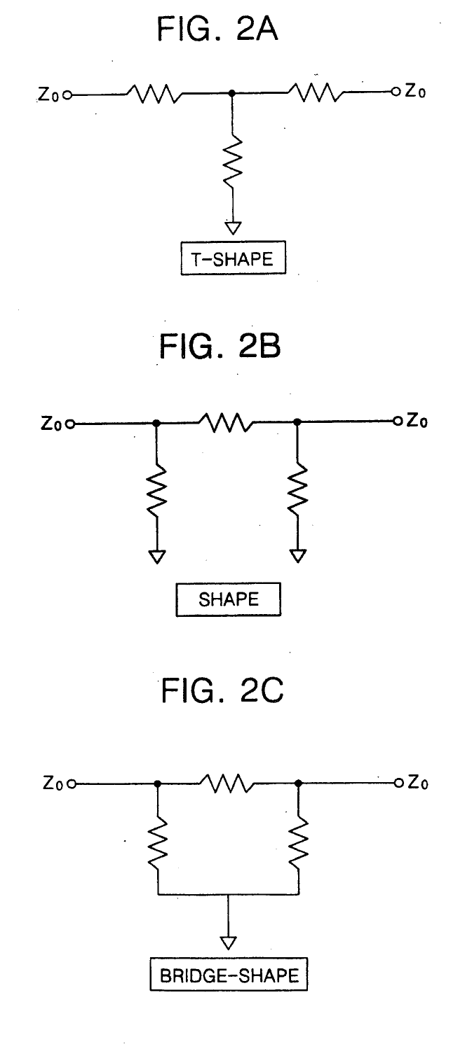

The attenuator 110 attenuates the received broadcast signal. Here, the attenuator 110 may be one of a T-shaped attenuator shown in FIG. 2a, a Π-shaped attenuator shown in FIG. 2b, and a bridge-shaped attenuator shown in FIG. 2c.

In addition, the controller 120 measures the power of the broadcast signal received from the cable broadcasting station 1, and sends a switching control signal to the switch switches 130a and 130b when the power exceeds the strong-electric-field critical value.

In addition, the switch 130a is disposed between broadcasting station 1 and the attenuator 110, and switches the broadcast signal received from the cable broadcasting station 1 to the attenuator 110 when the switching control signal is received from the controller 120.

General functions and detailed operations of each component mentioned above will not be described herein; only operations corresponding to the present invention will be described below.

First, in order to normally provide all subscribers with broadcast video via an old, worn broadcast line, the cable broadcasting station 1 amplifies a broadcast signal beyond a strong-electric-field critical value and sends the amplified broadcast signal to a set-top box of each subscriber via the broadcast line.

Subsequently, when the broadcast signal is received from the cable broadcasting station 1, the controller 120 measures its power. And, when the power of the broadcast signal exceeds the strong-electric-field critical value, the controller 120 sends a switching control signal to the switches 130a and 130b.

When the switching control signal is received from the controller 120, the switches 130a and 130b switch the broadcast signal received from the cable broadcasting station 1 to the attenuator 110.

Subsequently, the attenuator 110 attenuates the received broadcast signal. Here, the attenuator 110 is one of a T-shaped attenuator, a Π-shaped attenuator, and a bridge-shaped attenuator.

And then, the broadcast signal output from the attenuator 110 is applied again to the RF AGC 10.

Here, when the broadcast signal attenuated by the attenuator 110 is disposed in a linear gain section of the RF AGC 10, the RF AGC 10 controls the gain of the broadcast signal and outputs the gain-controlled broadcast signal to the following IF AGC 20.

The IF AGC 20 receives the gain-controlled broadcast signal and sends it to a decoder to display video when the received broadcast signal is not disposed in a linear gain section.

Subsequently, the decoder receives and decodes the broadcast signal, and provides a subscriber with the broadcast video through a display.

Meanwhile, when the broadcast signal whose power is attenuated by the attenuator 110 is not disposed in the linear gain section of the RF AGC 10, the RF AGC 10 outputs the broadcast signal to the following IF AGC 20 without controlling the gain of the broadcast signal.

The IF AGC 20 receives the broadcast signal from the RF AGC 10, and when the received broadcast signal is disposed in the linear gain section, controls the gain of the broadcast signal, and then sends the gain-controlled broadcast signal to the decoder to display the video of the broadcast signal.

Subsequently, the decoder receives and decodes the gain-controlled broadcast signal, and provides the subscriber with the broadcast video through the display.

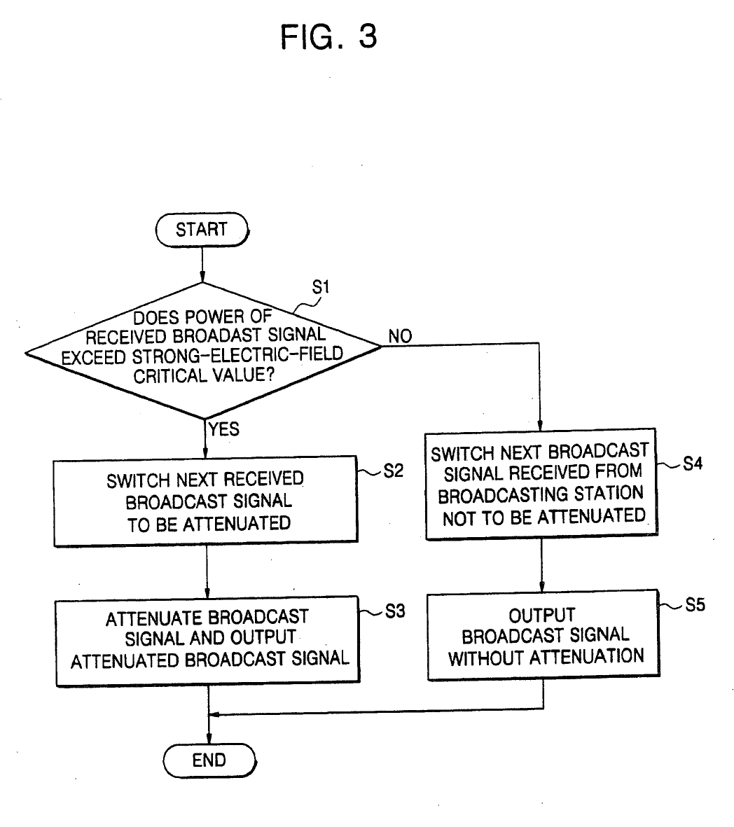

With reference to FIG. 3, a control method for the tuner will be described below, the tuner having an attenuation function and made up as described above according to an exemplary embodiment of the present invention.

First, the cable broadcasting station 1 amplifies a broadcast signal beyond a strong-electric-field critical value and broadcasts the amplified signal to each subscriber via a broadcast line. Then, it is judged if a power of the broadcast signal received from the cable broadcasting station 1 exceeds a strong-electric-field critical value (S1).

Here, when the power of the received broadcast signal exceeds the strong-electric-field critical value YES in the step of judging (S1), a control signal is sent and thus the next broadcast signal received from the cable broadcasting station 1 is switched to be attenuated (S2). Subsequently, the received broadcast signal is attenuated and output (S3).

On the other hand, when the power of the received broadcast signal does not exceed the strong-electric-field critical value NO in the step of judging (S1), another control signal is sent and thus the next broadcast signal received from the cable broadcasting station 1 is switched to not be attenuated (S4). Subsequently, the broadcast signal is output without attenuation (S5).

As described above, the tuner of the present invention having an attenuation function enables a powerful received broadcast signal to be attenuated and thus prevents interference between channels due to the powerful broadcast signal. Therefore, it is possible to provide stable broadcast video.

While the present invention has been described with reference to exemplary embodiments thereof, it will be understood by those skilled in the art that various changes in form and detail may be made therein without departing from the scope of the present invention as defined by the following claims. Obvious examples of modifications within the scope of the present invention include applying the inventive turner to a television (TV), a digital multimedia broadcasting (DMB) phone, or some other device rather than a set-top box.

What is claimed is:

1. A tuner automatically controlling a gain of a broadcast signal, comprising:
an attenuation unit, when the power of a broadcast signal received from a broadcasting station exceeds a strong-electric-field critical value, attenuating the broadcast signal and outputting the attenuated broadcast signal.

2. The tuner according to claim 1, wherein the attenuation unit comprises:
an attenuator attenuating the received broadcast signal;
a controller measuring the power of the broadcast signal received from the broadcasting station and sending a switching control signal when the measured power exceeds the strong-electric-field critical value; and
a switch switching the broadcast signal received from the broadcasting station to the attenuator when the switching control signal is received from the controller.

3. The tuner according to claim 2, wherein the attenuation unit is one of a T-shaped attenuator, a Π-shaped attenuator, and a bridge-shaped attenuator.

4. The tuner according to claim 2, wherein the switch comprises a pair of switches, wherein the attenuator is disposed between said pair of switches.

5. A method for a tuner to automatically control a gain of a broadcast signal, comprising step of:
when the power of a broadcast signal received from a broadcasting station exceeds a strong-electric-field critical value, attenuating the broadcast signal and outputting the attenuated broadcast signal.

6. The method according to claim 5, wherein the step of attenuating the broadcast signal received from the broadcasting station and outputting the attenuated broadcast signal comprises steps of:
judging whether the power of the broadcast signal received from the broadcastingstation exceeds the strong-electric-field critical value;
when the power of the received broadcast signal exceeds the strong-electric-field critical value in the step of judging, sending a control signal to perform switching such that the broadcast signal is thereafter attenuated; and
attenuating the received broadcast signal and outputting the attenuated broadcast signal.

7. The method for a tuner according to claim 6, further comprising steps of:
when the power of the received broadcast signal does not exceed the strong-electric-field critical value in the step of judging, sending another control signal to perform switching such that the broadcast signal is thereafter not attenuated; and
outputting the received broadcast signal without attenuation.
